(19) United States
(12) Patent Application Publication
(10) Pub. No.: US 2026/0257581 A1
(43) Pub. Date: Sep. 3, 2026

(54) Method and Device for Predicting the Waiting Time at a Charging Station

(71) Applicant: Bayerische Motoren Werke Aktiengesellschaft, Muenchen (DE)

(72) Inventors: Heidrun BELZNER, Seefeld (DE); Daniel KOTZOR, Seefeld (DE)

(21) Appl. No.: 18/868,232

(22) PCT Filed: Apr. 21, 2023
(86) PCT No.: PCT/EP2023/060499

§ 371 Date: Nov. 22, 2024

(30) Foreign Application Priority Data
Jun. 22, 2022 (DE) 10 2022 115 574.9

(51) Int. Cl. B60L 53/67; B60L 53/31; B60L 53/62; B60L 53/66; G06Q 50/40

(52) U.S. Cl. CPC B60L 53/67; B60L 53/31; B60L 53/62; B60L 53/66; G06Q 50/40; B60L 2240/72; B60L 2240/80

(57) ABSTRACT

A device for predicting a waiting time at a charging station includes n charging posts for carrying out n charging processes, where n≥1. The device is designed to determine state data regarding the occupancy of the n charging posts and of m additional waiting positions at the charging station at an initial point in time t0, where m≥1. The device is further designed to predict a waiting time for carrying out a charging process at the n charging posts at a prediction point in time t1 on the basis of an occupancy model of the n charging posts and the m waiting positions.

### BACKGROUND AND SUMMARY

The present disclosure relates to a method and a corresponding device for predicting the waiting time at a charging station.

An at least partially electrically driven vehicle has an electrical energy storage device which has to be charged as needed at a charging station. Due to relatively long charging periods for a charging process, a waiting time can occur at the charging station here, before a free charging point or a free charging column for the vehicle is available at the charging station.

The present document relates to the technical problem of predicting the expected waiting time at a charging station in an efficient and precise manner, in particular in order to adapt, in particular to optimize, the routing of a vehicle based thereon.

This object is achieved by the present disclosure. Advantageous embodiments are also described, inter alia, in the present disclosure. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device for predicting the waiting time at a charging station is described, which has n charging columns for carrying out n charging processes, with n≥1. Typically, only precisely one charging process can be carried out at the same time at each charging column. The waiting time can indicate the time which has to be waited at the charging station until a free charging column is available for a charging process.

The device is configured to ascertain status data with respect to the (current) occupancy of the n charging columns and of m additional waiting positions (each for one waiting vehicle) at the charging station at an initial time t₀, with m≥1. The status data can indicate the number of occupied charging columns and/or the number of occupied waiting positions at the initial time t₀. The device can be configured to request the status data from a (vehicle-external) server, in which status data with respect to a plurality of different charging stations are recorded. Alternatively or additionally, the status data, in particular the status data with respect to the m additional waiting positions, can be estimated. For this purpose, for example, the advancing behavior at the individual charging columns of the charging station can be analyzed. For example, it can be ascertained how quickly a charging column that becomes free is occupied again for a following charging process. The status data with respect to the m additional waiting positions can be estimated from the period for the reoccupation of a charging column. The status data can indicate the number of the currently occupied charging columns and optionally (if all charging columns are occupied) the number of the currently occupied waiting positions.

The device is furthermore configured to predict, on the basis of an occupancy model of the n charging columns and the m additional waiting positions, the waiting time for carrying out a charging process at the (in particular at precisely one of the) n charging columns at a prediction time t₁. The occupancy model can comprise a Markov chain model. The occupancy model can comprise n+1 different statuses for different numbers (0, 1, 2, n) of occupied charging columns. Furthermore, the occupancy model can comprise m different statuses for different numbers (1, 2, m) of occupied waiting positions. The different statuses of the occupancy model can be arranged here along a chain, in particular such that the n+1 different statuses for the different numbers of occupied charging columns follow one another with increasing number, and are followed by the m different statuses for increasing numbers of occupied waiting positions.

The occupancy model can depend on a charging request rate λ of requests to carry out charging processes and/or on a charging end rate μ of endings of charging processes. In particular, periods and/or rates of status transitions between the different statuses of the occupancy model can depend on the charging request rate λ and/or on the charging end rate μ. For example, the period and/or the rate of a status transition to a higher number of occupancies can depend on the charging request rate λ. On the other hand, the period and/or the rate of a status transition to a lower number of occupancies can depend on the charging end rate μ.

The charging request rate λ and/or the charging end rate μ are typically time-dependent. The device can be configured to ascertain the charging request rate λ and/or the charging end rate μ on the basis of measurement data with respect to the actual occupancy of the n charging columns and/or the m waiting positions in the past. Alternatively or additionally, the device can be configured to read the charging request rate λ and/or the charging end rate μ for the prediction time t₁ from a digital map, in which the charging station is recorded as a point of interest (POI). For this purpose, the charging request rate λ and/or the charging end rate μ can be relearned (possibly regularly) and updated in the digital map (for example, in the form of a map attribute).

A device is therefore described which enables the waiting times at one or more charging stations to be predicted in an efficient and reliable manner on the basis of an occupancy model, which also comprises a specific number of waiting positions in each case.

The device can furthermore be configured to effectuate a measure with respect to a routing of a vehicle in dependence on the ascertained waiting time. In particular, a driving route for an at least partially electrically driven vehicle can be ascertained in dependence on the ascertained waiting time. The level of comfort of an electrically driven vehicle can thus be increased in an efficient and reliable manner.

The periods and/or the rate of a status transition to a reduced number of occupied waiting positions can in particular depend on n·μ and/or correspond to n·μ in the occupancy model (wherein the operator “·” corresponds to a multiplication). The waiting time can thus be ascertained in a particularly efficient and precise manner.

The device can be configured to solve the following matrix differential equation of the occupancy model

$$\begin{matrix}{\dot{P}}_{0} & = & & & & - & λ & \cdot & {P}_{0} & & μ & \cdot & {P}_{1} \\ {\dot{P}}_{1} & = & λ & \cdot & {P}_{0} & - & ( λ + μ ) & \cdot & {P}_{1} & + & 2 \cdot μ & \cdot & {P}_{2} \\ {\dot{P}}_{2} & = & λ & \cdot & {P}_{1} & - & ( λ + 2 \cdot μ ) & \cdot & {P}_{2} & + & 3 \cdot μ & \cdot & {P}_{2} \\ ⋮ & ⋮ & ⋮ & ⋮ & ⋮ & ⋮ & ⋮ & ⋮ & ⋮ & ⋮ & ⋮ & ⋮ & ⋮ \\ {\dot{P}}_{n - 1} & = & λ & \cdot & {P}_{n - 2} & - & ( λ + ( n - 1 ) \cdot μ ) & \cdot & {P}_{n - 1} & + & n \cdot μ & \cdot & {P}_{n} \\ {\dot{P}}_{n} & = & λ & \cdot & {P}_{n - 1} & - & ( λ + n \cdot μ ) & \cdot & {P}_{n} & + & n \cdot μ & \cdot & {P}_{n + 1} \\ {\dot{P}}_{n + 1} & = & λ & \cdot & {P}_{n} & - & ( λ + n \cdot μ ) & \cdot & {P}_{n + 1} & + & n \cdot μ & \cdot & {P}_{n + 2} \\ ⋮ & ⋮ & ⋮ & ⋮ & ⋮ & ⋮ & ⋮ & ⋮ & ⋮ & ⋮ & ⋮ & ⋮ & ⋮ \\ {\dot{P}}_{n + m - 1} & = & λ & \cdot & {P}_{n + m - 2} & - & ( λ + n \cdot μ ) & \cdot & {P}_{n + m - 1} & + & n \cdot μ & \cdot & {P}_{n + m} \\ {\dot{P}}_{n + m} & = & λ & \cdot & {P}_{n + m - 1} & - & ( λ + n \cdot μ ) & \cdot & {P}_{n + m} & & & & \end{matrix}$$

in order to ascertain the waiting time. In this case, P₀(t), . . . , Pₙ(t) can be probabilities for the n+1 different statuses for different numbers of occupied charging columns at the time t. Pₙ₊₁(t), . . . , Pₙ₊ₘ(t) can be probabilities for m different statuses for different numbers of occupied waiting positions at the time t. The abovementioned matrix differential equation enables the waiting time to be predicted in a particularly precise manner.

The device can be configured, for example, to ascertain, on the basis of the occupancy model (in particular on the basis of the abovementioned matrix differential equation), the probability Pₙ(t₁) for the status that all n charging columns but no waiting position are occupied at the prediction time t₁. Furthermore, on the basis of the occupancy model (in particular on the basis of the abovementioned matrix differential equation), probabilities Pₙ₊₁(t₁), . . . , Pₙ₊ₘ(t₁) can be ascertained for m different statuses for different numbers of occupied waiting positions at the prediction time t₁ (wherein all n charging columns are occupied in each of the statuses). The waiting time can then be ascertained in a particularly precise manner on the basis of the probabilities Pₙ(t₁) and Pₙ₊₁(t₁), . . . , Pₙ₊ₘ(t₁).

The device can be configured in particular (on the basis of the charging end rate μ), for the status (211) that all n charging columns but no waiting position are occupied, to ascertain an individual waiting time, and to ascertain an individual waiting time for each of the m different statuses for the different numbers of occupied waiting positions. The individual waiting times for the status having i occupied waiting positions, for i=0, . . . , m, can be dependent on (i+1)/n·μ (or correspond to this value).

The waiting time can then be ascertained in a particularly precise manner on the basis of the individual waiting times and on the basis of the probabilities, in particular as an experiential value or as the median of the individual waiting times.

According to a further aspect, a (road) motor vehicle (in particular a passenger vehicle or a truck or a bus or a motorcycle) is described, which comprises the device described in this document.

According to a further aspect, a method for predicting the waiting time at a charging station is described, which comprises n charging columns for carrying out n charging processes, with n≥1. The method comprises ascertaining status data with respect to the (current) occupancy of the n charging columns and of m additional waiting positions at the charging station at an initial time t₀, with m≥1. The method furthermore comprises predicting, on the basis of an occupancy model of the n charging columns and the m waiting positions, the waiting time for carrying out a charging process at one of the n charging columns at a prediction time t₁ (which follows the initial time).

According to a further aspect, a software (SW) program is described. The SW program can be configured to be executed on a processor (for example, on a control unit of a vehicle or on a central computing unit), and to thus carry out the method described in this document.

According to a further aspect, a storage medium is described. The storage medium can comprise a SW program which is configured to be executed on a processor and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The present disclosure will be described in more detail hereinafter on the basis of exemplary embodiments.

### BRIEF DESCRIPTION OF THE DRAWINGS

FIG. 1 shows exemplary components of a vehicle;

FIG. 2a shows an exemplary charging station having a plurality of charging points;

FIG. 2b shows an exemplary model of the occupancy statuses of a charging station; and

FIG. 3 shows a flow chart of an exemplary method for predicting the waiting time at a charging station.

### DETAILED DESCRIPTION OF THE DRAWINGS

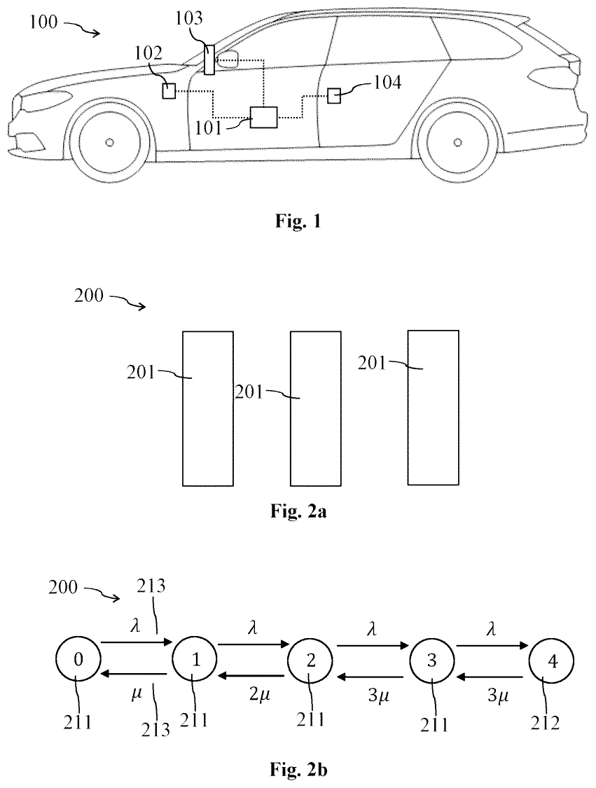

As described at the outset, the present document relates to the efficient and precise prediction of the expected waiting time of a vehicle at a charging station. In this context, FIG. 1 shows an exemplary vehicle 100 having a position sensor 102, which is configured to ascertain position data (for example, GNSS (global navigation satellite system) coordinates) with respect to the current position of the vehicle 100. The position data can be evaluated (by a (control) device 101 of the vehicle 100) in conjunction with a digital map for the roadway network traveled by the vehicle 100, in order to ascertain the position of the vehicle 100 within the roadway network.

The digital map can comprise information with respect to charging stations for charging vehicle batteries. The information with respect to a charging station can comprise
the position of the charging station (within the roadway network); and
the number of different charging points (wherein one vehicle at a time can be charged at each charging point).

The vehicle 100 can comprise a communication unit 104, which is configured to communicate with a vehicle-external unit (for example with a server) via a (wireless) communication connection (e.g., 3G, 4G, 5G, etc.), for example, to receive current information with respect to a charging station.

Furthermore, the vehicle 100 can comprise a user interface 103 for an interaction with a user of the vehicle 100. It can be made possible for a user to plan a driving route through the roadway network (starting from the current position up to a destination position). One or more stops at one or more corresponding charging stations along the driving route can also be planned here, in order to charge the electrical energy storage device of the vehicle 100. The routing along the planned driving route can be effectuated via the user interface 103 of the vehicle 100.

FIG. 2a shows an exemplary charging station 200 having a plurality of different charging points or charging columns 201.

It can occur in particular at peak times that all charging points 201 of a charging station 200 are occupied, so that a waiting time results for the start of a charging process. The presence of a relatively long waiting time at a charging station 200 can have the result that the vehicle 100 is not to drive toward this charging station 200, and instead is to drive toward another charging station 200 (along the driving route to the destination position). The waiting times (to be expected) at the different charging stations 200 can therefore be taken into consideration in the planning of a driving route in order to reduce, in particular to minimize, the effective travel time of the driving route (including the time for carrying out one or more charging processes).

Measures are described in the present document, using which the expected waiting time at a charging station 200 can be predicted in an efficient and precise manner.

As described above, information can be provided in the digital map for a charging station 200 (for example, as a map attribute and/or as a point of interest (POI)). The map attribute can be of the type POItype=charging. Such a POI (i.e. such a charging station 200) can have n charging columns (i.e. charging points) 201, wherein the n charging columns form a charging pool. A POI 200 can therefore assume n+1 statuses or degrees of filling, in particular the statuses “no space within the pool occupied”, “one space of the pool occupied”, all spaces of the pool occupied.

The precise number of the available charging columns 201 of the POI 200 can change over time due to vehicles approaching and driving away and is generally unknown. The modeling of the current number of available charging columns 201 can be carried out by a vector P(t)=(P₀(t), . . . , Pₙ(t))^{T}. Pᵢ(t) designates the probability that at the time t, i charging columns 201 of the POI 200 are occupied, wherein for all times ΣPᵢ(t)=1 applies.

The following time-dependent parameters can be defined
charging request rate λ (frequency at which charging processes are requested at the charging pool 200); and/or
charging end rate μ (reciprocal of the mean charging duration per vehicle at the charging pool 200).

The abovementioned parameters can be estimated on the basis of acquired occupancy data from the past. The values of the parameters are typically time-dependent. In particular, the values of the parameters can be dependent on
the time of day;
the day of the week;
the type of day (holiday or weekday); and/or.
school holidays.

The values of the parameters λ, μ can be ascertained online or in preparation on the basis of the acquired occupancy data from the past, and can possibly be recorded as attributes for the charging station 200 in the digital map (and thus read out if needed).

FIG. 2b illustrates an exemplary birth-death Markov chain model 210, which can be used for ascertaining the waiting time to be expected at a charging station 200. The model 210 shown in FIG. 2b applies for a charging station 200 having n=3 charging columns 201, and comprises a node point or status 211 (0, 1, 2, or 3 occupied charging columns 201) for each possible occupancy status of the charging columns 201. Furthermore, the model 210 comprises a node point or status 212 for an additional waiting position (node point 212 having the number “4”). In general, the model 210 can have m node points or statuses 212 for m waiting positions, for example, for one or more, or two or more, or three or more waiting positions.

These status transitions 213 between the node points 211, 212 depend on the abovementioned parameters. The occupancy of the charging columns 201 and the waiting positions increases according to the charging request rate λ. On the other hand, the occupancy of the charging columns 201 and the waiting positions decreases according to the charging end rate μ. It is to be taken into consideration that with n occupied charging columns 201, it is sufficient for the charging process to be ended at one of the n occupied charging columns 201 in order to create a free charging column 201 (so that the rate for the corresponding status transition is n·μ). In a corresponding manner, with n−1 occupied charging columns 201, it is sufficient for the charging process to be ended at one of the n−1 occupied charging columns 201 in order to only still have n−2 charging columns 201 (so that the rate for the corresponding status transition is (n−1)·μ). Furthermore, with n occupied charging columns 201, it is sufficient for the charging process to be ended at one of the n occupied charging columns 201 in order to reduce a waiting position (so that the rate for the corresponding status transition is n·μ).

The probability vector P(t₁) at the time t₁ can be calculated in consideration of a prior status P(t₀) as an initial value problem of the following matrix differential equation and represents an estimator for the status at an arbitrary future time:

$$\begin{matrix}{\dot{P}}_{0} & = & & & & - & λ & \cdot & {P}_{0} & & μ & \cdot & {P}_{1} \\ {\dot{P}}_{1} & = & λ & \cdot & {P}_{0} & - & ( λ + μ ) & \cdot & {P}_{1} & + & 2 \cdot μ & \cdot & {P}_{2} \\ {\dot{P}}_{2} & = & λ & \cdot & {P}_{1} & - & ( λ + 2 \cdot μ ) & \cdot & {P}_{2} & + & 3 \cdot μ & \cdot & {P}_{2} \\ ⋮ & ⋮ & ⋮ & ⋮ & ⋮ & ⋮ & ⋮ & ⋮ & ⋮ & ⋮ & ⋮ & ⋮ & ⋮ \\ {\dot{P}}_{n - 1} & = & λ & \cdot & {P}_{n - 2} & - & ( λ + ( n - 1 ) \cdot μ ) & \cdot & {P}_{n - 1} & + & n \cdot μ & \cdot & {P}_{n} \\ {\dot{P}}_{n} & = & λ & \cdot & {P}_{n - 1} & - & ( λ + n \cdot μ ) & \cdot & {P}_{n} & + & n \cdot μ & \cdot & {P}_{n + 1} \\ {\dot{P}}_{n + 1} & = & λ & \cdot & {P}_{n} & - & ( λ + n \cdot μ ) & \cdot & {P}_{n + 1} & + & n \cdot μ & \cdot & {P}_{n + 2} \\ ⋮ & ⋮ & ⋮ & ⋮ & ⋮ & ⋮ & ⋮ & ⋮ & ⋮ & ⋮ & ⋮ & ⋮ & ⋮ \\ {\dot{P}}_{n + m - 1} & = & λ & \cdot & {P}_{n + m - 2} & - & ( λ + n \cdot μ ) & \cdot & {P}_{n + m - 1} & + & n \cdot μ & \cdot & {P}_{n + m} \\ {\dot{P}}_{n + m} & = & λ & \cdot & {P}_{n + m - 1} & - & ( λ + n \cdot μ ) & \cdot & {P}_{n + m} & & & & \end{matrix}$$

The above model can be expanded for the modeling of waiting times in that degrees of occupation n+1, n+2, . . . , n+m are introduced, which represent m waiting positions. A vehicle 100 in a waiting position can therefore be represented as a virtual expansion of the charging pool 200 by a further charging column 201. It is to be taken into consideration here that for the transition from status n to n+1, the charging request rate λ applies, for the transition from status n+1 to n, namely when an automobile leaves the charging station, the charging end rate nμ applies, since all n charging stations 201 are still occupied.

The solution of the abovementioned matrix differential equation, which can be obtained, for example, via the matrix exponents, offers the following results:
The probabilities P₀(t₁), . . . , Pₙ(t₁) of the different degrees of occupancy of the charging columns 201 at the (preceding) time t₁, and the probabilities Pₙ₊₁(t₁), . . . , Pₙ₊ₘ(t₁) of the occupancy of the different m waiting positions.
The speed at which the degrees of occupancy of the charging columns 201 and/or the waiting positions change. Since all statistical state transitions 213 are known by means of λ and μ, the times for arbitrary state transitions 213 within the expanded pool 200 can be read from the model 210. In particular for the case that all charging spaces 201 are occupied, the expected waiting time can be ascertained. For example, the waiting time t_{wait}=⅓μ+⅓μ=⅔μ can be calculated for the case that the vehicle 100 in the example from FIG. 2b is at the waiting position.

The following can thus be ascertained
\vec{P}: the probability vector for the statuses at a requested time; and/or
t_{wait}: the expected waiting time at the requested time.

A system is therefore described which calculates an estimation of the availability and waiting time on the basis of occupancy data of charging stations 200. Other input data can be real-time information from vehicles.

Components of the system can be:
static geo-position data for the charging pools 200;
historic availability data of individual charging stations 200 up to the current time as an input into the system (POI data of the charging station operators);
computing unit for the compilation of individual charging station availabilities to form statements with respect to the pools (i charging columns occupied in the segment);
computing unit for processing incoming data and preparing requested charging information; and/or
interface to call and output the prediction data.

Vehicle users typically wish to reach a destination safely and without unplanned waiting times. A prediction which relates to statements about availability and waiting time at charging stations 200 enables routes to be planned which avoid or minimize waiting times. The transparency about waiting times enables waiting times to be planned beforehand and possibly better used.

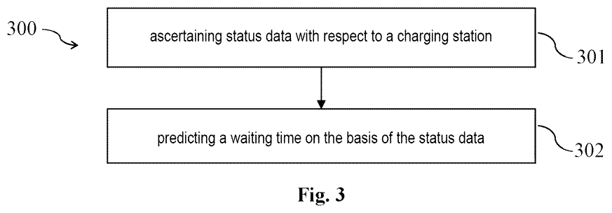

FIG. 3 shows a flow chart of an exemplary (possibly computer-implemented) method 300 for predicting the waiting time at a charging station 200, which has n charging columns 201 for carrying out n charging processes, with n≥1. The method 300 can be carried out by a device 101 of a vehicle 100 (for example in the context of the route planning).

The method 300 comprises ascertaining 301 status data with respect to the occupancy of the n charging columns 201 and of m additional waiting positions at the charging station 200 at an initial time t₀, with m≥1. The status data can be requested, for example, directly from the charging station 200. The initial time can correspond to the current time.

The method 300 furthermore comprises predicting 302, on the basis of an occupancy model 210 of the n charging columns 201 and the m waiting positions, the waiting time to carry out a charging process at one of the n charging columns 201 at an (upcoming) prediction time t₁. The occupancy model 210 can be, for example, a Markov chain model. Alternatively or additionally, the occupancy model 210 can comprise a matrix differential equation (as described in this document). The occupancy model 210 can depend on the (statistically ascertained) charging request rate λ of requests to carry out charging processes and/or on the (statistically ascertained) charging end rate μ of endings of charging processes.

The expected waiting time to carry out charging processes can be estimated in an efficient and precise manner by the measures described in this document, due to which, for example, the routing of a vehicle 100 can be optimized.

The present invention is not restricted to the exemplary embodiments shown. In particular, it is to be noted that the description and the figures are only to illustrate by way of example the principle of the proposed methods, devices, and systems.

1-12. (canceled)

13. A device for predicting a waiting time at a charging station, which has n charging columns for carrying out n charging processes, with n≥1, wherein the device is configured to:
ascertain status data with respect to an occupancy of the n charging columns and of m additional waiting positions at the charging station at an initial time t₀, with m≥1; and
predict a waiting time to carry out a charging process at the n charging columns at a prediction time t₁ on a basis of an occupancy model of the n charging columns and the m additional waiting positions, wherein the occupancy model depends on a charging request rate λ of requests to carry out charging processes and on a charging end rate μ of endings of charging processes.

14. The device according to claim 13, wherein
the occupancy model comprises n+1 different statuses for different numbers of occupied charging columns,
the occupancy model comprises m different statuses for different numbers of occupied waiting positions, and
periods of time and/or rates of status transitions between the different statuses of the occupancy model depend on the charging request rate λ and/or on the charging end rate μ.

15. The device according to claim 14, wherein
the different statuses of the occupancy model are arranged along a chain such that the n+1 different statuses for the different numbers of occupied charging columns follow one another with increasing number, and are followed by the m different statuses for increasing numbers of occupied waiting positions,
the period of time and/or the rate of a status transition to a higher number of occupancies depends on the charging request rate λ, and
the period of time and/or the rate of a status transition to a lower number of occupancies depends on the charging end rate μ.

16. The device according to claim 14, wherein the periods of time and/or the rate of a status transition to a reduced number of occupied waiting positions depends on n·μ.

17. The device according to claim 13, wherein the device is configured to:
ascertain, on a basis of the occupancy model, a probability Pₙ(t₁) for the status that at the prediction time t₁ all n charging columns are occupied, but no waiting position is occupied;
ascertain, on the basis of the occupancy model, probabilities Pₙ₊₁(t₁), . . . , Pₙ₊ₘ(t₁) for m different statuses for different numbers of occupied waiting positions at the prediction time t₁; and
ascertain the waiting time on a basis of the probabilities Pₙ(t₁) and Pₙ₊₁(t₁), . . . , Pₙ₊ₘ(t₁).

18. The device according to claim 17, wherein the device is configured to:
on a basis of the charging end rate μ:
ascertain an individual waiting time for the status that all n charging columns are occupied, but no waiting position is occupied;
ascertain an individual waiting time for each of the m different statuses for the different numbers of occupied waiting positions; and
ascertain the waiting time on the basis of the individual waiting times and on the basis of the probabilities as an experiential value or as a median of the individual waiting times.

19. The device according to claim 18, wherein the individual waiting time for the status with i occupied waiting positions, for i=0, . . . , m, is dependent on (i+1)/n·μ.

20. The device according to claim 13, wherein the device (101) is configured to:
solve the following matrix differential equation of the occupancy model:
$$\begin{matrix}{\dot{P}}_{0} & = & & & & - & λ & \cdot & {P}_{0} & & μ & \cdot & {P}_{1} \\ {\dot{P}}_{1} & = & λ & \cdot & {P}_{0} & - & ( λ + μ ) & \cdot & {P}_{1} & + & 2 \cdot μ & \cdot & {P}_{2} \\ {\dot{P}}_{2} & = & λ & \cdot & {P}_{1} & - & ( λ + 2 \cdot μ ) & \cdot & {P}_{2} & + & 3 \cdot μ & \cdot & {P}_{2} \\ ⋮ & ⋮ & ⋮ & ⋮ & ⋮ & ⋮ & ⋮ & ⋮ & ⋮ & ⋮ & ⋮ & ⋮ & ⋮ \\ {\dot{P}}_{n - 1} & = & λ & \cdot & {P}_{n - 2} & - & ( λ + ( n - 1 ) \cdot μ ) & \cdot & {P}_{n - 1} & + & n \cdot μ & \cdot & {P}_{n} \\ {\dot{P}}_{n} & = & λ & \cdot & {P}_{n - 1} & - & ( λ + n \cdot μ ) & \cdot & {P}_{n} & + & n \cdot μ & \cdot & {P}_{n + 1} \\ {\dot{P}}_{n + 1} & = & λ & \cdot & {P}_{n} & - & ( λ + n \cdot μ ) & \cdot & {P}_{n + 1} & + & n \cdot μ & \cdot & {P}_{n + 2} \\ ⋮ & ⋮ & ⋮ & ⋮ & ⋮ & ⋮ & ⋮ & ⋮ & ⋮ & ⋮ & ⋮ & ⋮ & ⋮ \\ {\dot{P}}_{n + m - 1} & = & λ & \cdot & {P}_{n + m - 2} & - & ( λ + n \cdot μ ) & \cdot & {P}_{n + m - 1} & + & n \cdot μ & \cdot & {P}_{n + m} \\ {\dot{P}}_{n + m} & = & λ & \cdot & {P}_{n + m - 1} & - & ( λ + n \cdot μ ) & \cdot & {P}_{n + m} & & & & \end{matrix}$$
in order to ascertain the waiting time,
wherein P₀ (t), . . . , Pₙ(t) are probabilities for n+1 different statuses for different numbers of occupied charging columns at the time t, and
wherein Pₙ₊₁(t), . . . , Pₙ₊ₘ(t) are probabilities for m different statuses for different numbers of occupied waiting positions at the time t.

21. The device according to claim 13, wherein the device is configured to:
effectuate a measure with respect to routing of a vehicle in dependence on the ascertained waiting time; and/or
ascertain a driving route for an at least partially electrically driven vehicle in dependence on the ascertained waiting time.

22. The device according to claim 13,
wherein the charging request rate λ and/or the charging end rate μ are time-dependent, and
wherein the device is configured to:
ascertain the charging request rate λ and/or the charging end rate μ on a basis of measurement data with respect to the actual occupancy of the n charging columns and/or the m waiting positions in the past; and/or
read the charging request rate λ and/or the charging end rate μ for the prediction time t₁ from a digital map, in which the charging station is recorded as a point of interest.

23. The device according to claim 13,
wherein the status data indicates a number of occupied charging columns and/or a number of occupied waiting positions at the initial time t₀, and/or
wherein the device is configured to request the status data from a server in which status data with respect to a plurality of different charging stations are recorded.

24. A method for predicting a waiting time at a charging station, which has n charging columns for carrying out n charging processes, with n≥1, the method comprising:
ascertaining status data with respect to an occupancy of the n charging columns and of m additional waiting positions at the charging station at an initial time t₀, with m≥1; and
predicting, on a basis of an occupancy model of the n charging columns and the m waiting positions, a waiting time to carry out a charging process at one of the n charging columns at a prediction time t₁, wherein the occupancy model depends on a charging request rate λ of requests to carry out charging processes and on a charging end rate μ of endings of charging processes.

25. The method according to claim 24, wherein
the occupancy model comprises n+1 different statuses for different numbers of occupied charging columns,
the occupancy model comprises m different statuses for different numbers of occupied waiting positions, and
periods of time and/or rates of status transitions between the different statuses of the occupancy model depend on the charging request rate λ and/or on the charging end rate μ.

26. The method according to claim 25, wherein
the different statuses of the occupancy model are arranged along a chain such that the n+1 different statuses for the different numbers of occupied charging columns follow one another with increasing number, and are followed by the m different statuses for increasing numbers of occupied waiting positions,
the period of time and/or the rate of a status transition to a higher number of occupancies depends on the charging request rate λ, and
the period of time and/or the rate of a status transition to a lower number of occupancies depends on the charging end rate μ.

27. The method according to claim 25, wherein the periods of time and/or the rate of a status transition to a reduced number of occupied waiting positions depends on n·μ.

28. The method according to claim 25, comprising:
ascertaining, on a basis of the occupancy model, a probability Pₙ(t₁) for the status that at the prediction time t₁ all n charging columns are occupied, but no waiting position is occupied;
ascertaining, on the basis of the occupancy model, probabilities Pₙ₊₁(t₁), . . . , Pₙ₊ₘ(t₁) for m different statuses for different numbers of occupied waiting positions at the prediction time t₁; and
ascertaining the waiting time on a basis of the probabilities Pₙ(t₁) and Pₙ₊₁(t₁), . . . , Pₙ₊ₘ(t₁).

29. The method according to claim 28, comprising:
on a basis of the charging end rate μ:
ascertaining an individual waiting time for the status that all n charging columns are occupied, but no waiting position is occupied;
ascertaining an individual waiting time for each of the m different statuses for the different numbers of occupied waiting positions; and
ascertaining the waiting time on the basis of the individual waiting times and on the basis of the probabilities as an experiential value or as a median of the individual waiting times.

30. The method according to claim 24, comprising:
effectuating a measure with respect to routing of a vehicle in dependence on the ascertained waiting time; and/or
ascertaining a driving route for an at least partially electrically driven vehicle in dependence on the ascertained waiting time.

31. The method according to claim 24,
wherein the charging request rate λ and/or the charging end rate μ are time-dependent, the method comprising:
ascertaining the charging request rate λ and/or the charging end rate μ on a basis of measurement data with respect to the actual occupancy of the n charging columns and/or the m waiting positions in the past; and/or
reading the charging request rate λ and/or the charging end rate μ for the prediction time t₁ from a digital map, in which the charging station is recorded as a point of interest.

32. The method according to claim 24,
wherein the status data indicates a number of occupied charging columns and/or a number of occupied waiting positions at the initial time t₀, and/or
wherein the method comprises requesting the status data from a server in which status data with respect to a plurality of different charging stations are recorded.
